(19) United States
(12) Patent Application Publication
(10) Pub. No.: US 2012/0037243 A1
(43) Pub. Date: Feb. 16, 2012

(54) Pressure Equalization Assembly for a Storage Vessel

(75) Inventors: Julian S. Taylor, Oklahoma City, OK (US); John Alan Boyd, III, Oklahoma City, OK (US)

(73) Assignee: TAYLOR INNOVATIONS, L.L.C., Oklahoma City, OK (US)

(21) Appl. No.: 13/281,003

(22) Filed: Oct. 25, 2011

Related U.S. Application Data
(63) Continuation-in-part of application No. 12/489,886, filed on Jun. 23, 2009.
(60) Provisional application No. 61/170,442, filed on Apr. 17, 2009.

(51) Int. Cl. G05D 16/14

(52) U.S. Cl. 137/209

(57) ABSTRACT

Apparatus for equalizing pressure within a vapor space of a storage vessel. In accordance with various embodiments, a pressure equalization assembly has a base housing member adapted to be mounted to a tank adjacent a tank aperture in fluidic communication with a vapor space of the tank. A canister assembly is adapted for removable engagement with the housing member between a closed position and an open position. The closed position establishes a fluidic seal interface between the housing member and the canister assembly. The open position provides user access to the vapor space through the tank aperture. The canister assembly further has a compound seal assembly with first and second pistons biased against corresponding first and second annular seal members while the canister assembly is in both the closed position and the open position. A third annular seal member is disposed between the canister assembly and the base housing member.

### RELATED APPLICATION

This application is a continuation-in-part to U.S. patent application Ser. No. 12/489,886 filed Jun. 23, 2009, which makes a claim of domestic priority under U.S.C. §119(e) to U.S. Provisional Patent Application No. 61/170,442 filed Apr. 17, 2009.

### BACKGROUND

It is common to collect and store multi-phase fluids, such as liquid and gas phases, in storage vessels or tanks. Such fluids can include oil and other hydrocarbon based fluids, water (fresh or brine), hazardous chemicals and the like. Storage vessels can be buried underground, such as underground fuel storage tanks used in automotive service stations, or they can be located above ground, such as storage tanks used in drilling and refining operations in the oil and gas industry and storage tanks for drinking water in municipal water supply systems.

Storage vessels vary widely in size, and are often sized to accommodate thousands and even millions of liquid gallons. Such vessels can be designed to be open or closed systems, with closed vessels used to store various types of pressurized fluids, such as liquefied natural gas (LNG) or other volatile fluids. It is often necessary that closed system vessels be sealed from the ambient atmosphere to maintain the contents under pressure and hence usually in a liquid state.

Open vessels, which maintain communication with some source of reference pressure, usually the ambient atmosphere, are susceptible to migration of environmental pollutants, so such vessels may be provided with screened vents or other mechanisms to allow equalization of the vessel's vapor space with the reference pressure source. For example, it may be desirable to admit an outside fluid, such as atmospheric air to the vessel vapor space as liquid is pumped or gravity fed from the vessel, and it may be desirable to release pressure from the vapor space as additional liquid is accumulated.

Ambient conditions can alter the interior pressure of a storage vessel, such as, for example, during a hot summer day solar heating of the storage vessel can substantially increase the internal pressure of the vessel as compared to the ambient atmospheric pressure.

Failure to maintain the interior vapor space of a storage vessel within some acceptable pressure range can result in a number of problems, such as reduced fluid flow as efforts are made to transfer liquid to or from the vessel. In some extreme cases, a significant pressure differential may even result in structural damage to a vessel.

At the same time, there are a number of reasons why it may not be desirable to maintain continuous venting of a liquid storage vessel to the surrounding atmosphere. For example, a continuously open vent, even if screened, can admit debris or other substances from the external environment, thereby introducing undesirable contaminants to the stored liquid. Thus, it is sometimes required that the vapor pressure be maintained with reference to a reference pressure source, such as an inert blanket gas.

Similarly, evaporated vapors or fumes from the stored liquid, such as water vapor or volatile hydrocarbons, may pass through a continuously open vent to the surrounding atmosphere at an unacceptable rate. This can lead to an undesired loss of product or, in some cases, unacceptable levels of environmental emissions.

### SUMMARY

Various embodiments are generally directed to an apparatus for equalizing pressure within a vapor space of a storage vessel.

In accordance with some embodiments, a pressure equalization assembly generally includes a base housing member adapted to be mounted to a tank adjacent a tank aperture in fluidic communication with a vapor space of the tank. A canister assembly is adapted for removable engagement with the housing member between a closed position and an open position. The closed position establishes a fluidic seal interface between the housing member and the canister assembly. The open position provides user access to the vapor space through the tank aperture.

The canister assembly further has a compound seal assembly with first and second pistons biased against corresponding first and second seal members while the canister assembly is in both the closed position and the open position. A third annular seal member is disposed between the canister assembly and the base housing member to establish the fluidic seal interface.

Other features and advantages of the various embodiments disclosed herein will become apparent when the following detailed description is read in conjunction with the drawings and appended claims.

### BRIEF DESCRIPTION OF THE DRAWINGS

FIG. 1 is an elevational, partially cutaway view of an exemplary storage tank having mounted thereon a pressure equalization assembly constructed in accordance with various embodiments.

FIG. 2 is an elevational view of the pressure equalization assembly of FIG. 1.

FIG. 3 is a cross-sectional view of the pressure equalization assembly of FIG. 2.

FIG. 4 is an enlarged cross-sectional view of a portion of the vapor equalization assembly of FIG. 3.

FIG. 5 illustrates selected portions of the assembly of FIGS. 2-4 in a vacuum relief mode of operation.

FIG. 6 illustrates selected portion of the assembly of FIGS. 2-4 in an overpressure relief mode of operation.

FIG. 7 is an exploded elevational representation of the assembly of FIGS. 2-4.

FIG. 8 shows an alternative pressure equalization assembly in accordance with various embodiments, the embodiment of FIG. 8 adapted for use to cover a thief hatch access aperture of a liquid storage tank.

FIG. 8A is an enlarged view of a portion of FIG. 8.

FIG. 9 shows the assembly of FIG. 8 in an open position.

FIG. 10 illustrates a calibration operation that may be carried out in accordance with various embodiments.

### DETAILED DISCUSSION

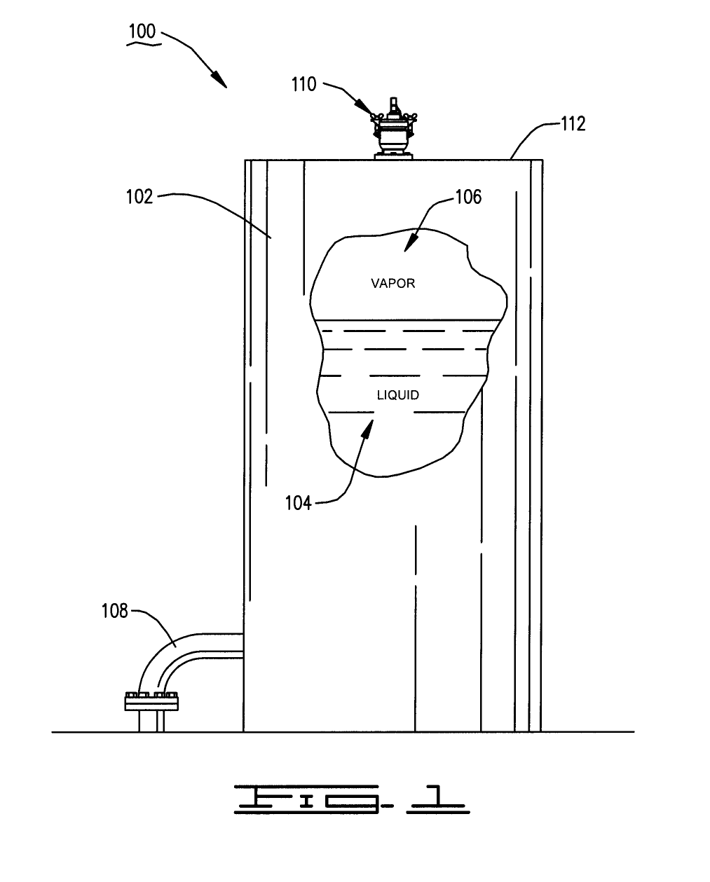

Referring to the drawings in general and FIG. 1 in particular, shown therein is a storage system 100 constructed in accordance with various embodiments. The storage system 100 includes an exemplary storage vessel 102 adapted to hold a liquid 104 above which is a vapor space 106. Due to the normally sealed nature of the storage vessel 102, evaporated vapors or fumes from the liquid 104 accumulate in the vapor space 106. For purposes of an explicit example, the liquid 104 is contemplated as a non-pressurized hydrocarbon liquid, such as crude oil or similar such liquid. Other liquids, of course, especially other hydrocarbon liquids, could as well be stored in the storage vessel 102. As will be appreciated, a number of factors may result in changes in the pressure of the vapor space 106 over time. Environmental cycling, such as thermal heating and cooling effects, may result in significant changes in the internal pressure of the vapor space 106 within the tank 102. The pressure of the vapor space 106 may also vary with changes in the amount of liquid 104 in the storage vessel 102, generally rising as additional liquid is introduced into the vessel, and generally decreasing as liquid is removed. Fluid transfer to and from the vessel 102 is through a transfer conduit 108.

A pressure equalization assembly 110 is mounted on the storage vessel 102 in fluid communication with the vapor space 106. As described below, the pressure equalization assembly 110 normally operates in a closed mode, that is, in the mode that seals the vapor space 106 to prevent harmful pollutants from being emitted from the vessel 102 into the surrounding environment. When the pressure of the vapor space 106 falls outside a predetermined pressure range, the pressure equalization assembly 110 assumes its open mode, converting the storage vessel 102 to an open system and connecting the vapor space 106 with an outside reference fluid source, which in the present embodiment is the surrounding atmosphere.

The aforementioned predetermined pressure range is defined as a pressure range bounded by an upper pressure value and a lower pressure value, and when the vessel pressure exceeds the upper pressure value, the pressure equalization assembly 110 opens to discharge vapors from the vapor space 106, such as to the atmosphere. Once the pressure in the vapor space 106 has been reduced to equal the upper pressure value, the pressure equalization assembly 110 transitions the storage system 100 back to the normally closed mode.

Similarly, should the pressure in the vapor space 106 falls below the lower pressure value of the pressure range, the pressure equalization assembly 110 opens to allow a reference pressure fluid, in the present embodiment, atmospheric air, into the vapor space 106 until the pressure reaches the lower pressure value, at which time the pressure equalization assembly 110 transitions the storage system 100 back to the normally closed mode.

While the pressure equalization assembly 110 is shown in FIG. 1 as mounted to a top plate 112 of the storage vessel 102, it will be understood that any suitable mounting location on the vessel can be used, so long as the pressure equalization assembly 110 is maintained in fluid communication with the vapor space 106.

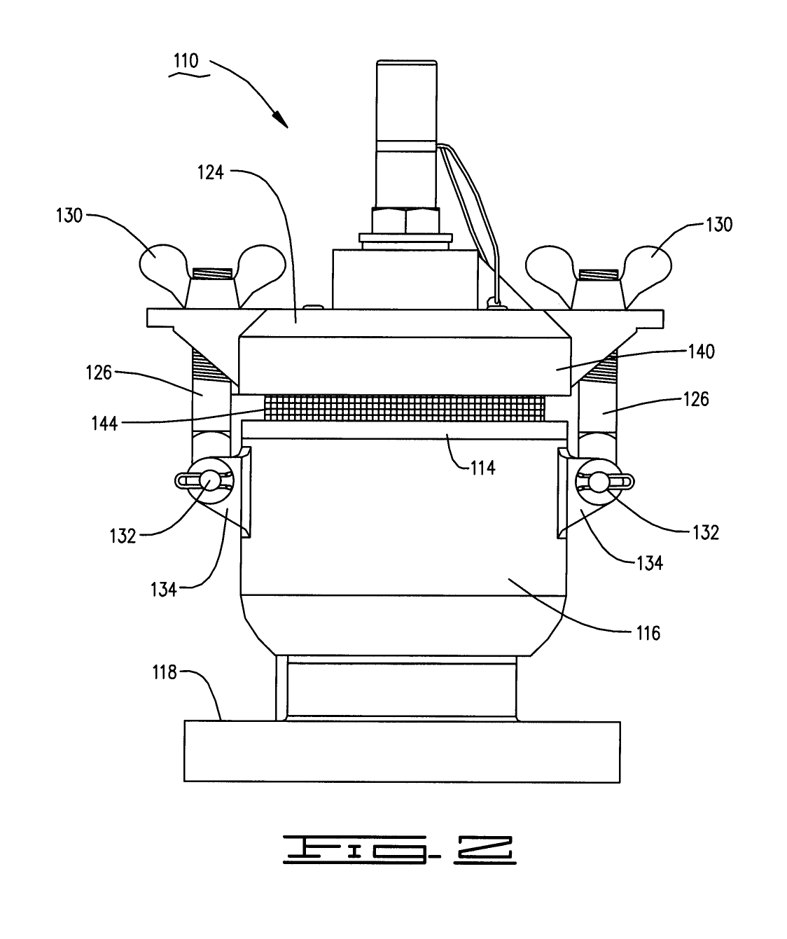

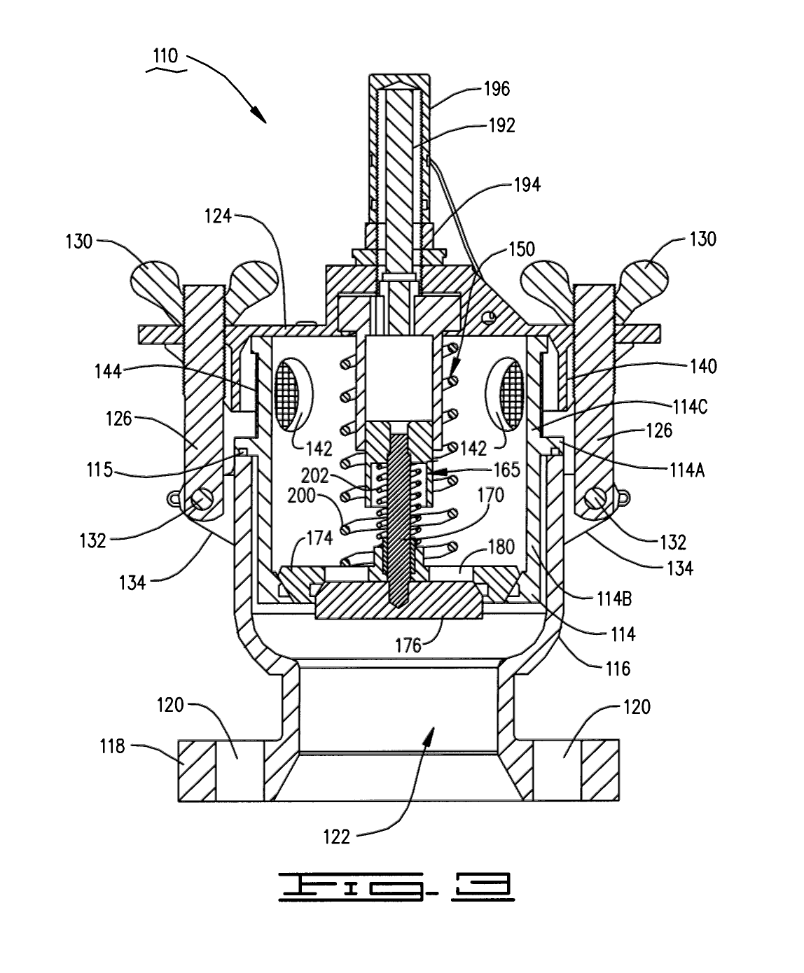

As shown in FIGS. 2 and 3, the pressure equalization assembly 110 includes an underpressure (that is, a vacuum) relief mechanism and an overpressure relief mechanism, described herein below, that are disposed within a support canister, or upper housing, 114. The support canister 114 is generally a hollow cylindrical member that is supported by a base housing member (body member) 116; the support canister 114 and body member 116 together provide a housing. The body member 116 has a bolting flange 118 at its lower portion. The bolting flange 118 has a plurality of bolt holes 120 (FIG. 3) through which bolts (not shown) extend to engage threaded holes in the top plate 112 of the storage vessel 102. The treaded holes in the top plate 112 circumscribe an entry port (not shown) that communicates with the storage vessel 102 so that the body member 116 of the pressure equalization assembly 110 will be in fluid communication with the vapor space 106 when mounted to the top plate 112.

The body member 116 has an internal passageway 122 extending the length of thereof, and the support canister 114 is supported on the upper portion of the body member 116 by a circularly extending projecting flange 114A. A lower portion 114B of the support canister 114 extends downwardly into the internal passageway 122, and an upper portion 114C thereof projects upwardly from the body member 116. An elastomeric sealing member 115 is disposed within an annular channel in the flange 114A to sealingly engage the body member 116.

A hooding cap 124 fits over the upper end of the upper portion 114C, thereby substantially closing the upper end of the passageway 122. The hooding cap 124 is connected to the body member 116 by a pair of mounting bolts 126 connected to the external wall of the body member 116 and that extend through holes or slots (not separately numbered) in the hooding cap 124 and secured thereby with hand tightened wing nuts 130.

Each of the bolts 126 has a cross pin member 132 (FIG. 2) at its lower end, the pin member 132 of each bolt 126 pivotally supported in axially aligned bores in a pair of parallel tab member 134 attached on opposing sides of the outer surface of the body member 116. The pin members 132 are secured in the bores of the tab members 132 by locking clips 136 pressed into appropriately located locking grooves in the pin members 132 in the manner shown. With the bolts 126 loosened and pivoted aside, the hooding cap 124 can be removed to provide access to, and possibly removal of, the support canister 114.

The hooding cap 124 is a weather guard having an annular cap flange member 140 that extends about and is spaced from the outer surface of the upper housing 114C. The upper housing 114C has a several spaced apart vent holes 142 that are spatially disposed about the housing 114C near its top portion and arranged to be partially hooded by the annular flange 140. As necessary, a wire mesh screen member 144 or the like is positioned to cover the vent holes 142 to prevent debris from entering the internal passageway 122.

A first piston assembly 150 normally seals the vapor space 106 from the surrounding atmosphere by engaging an annular seat 152 that is characterized as an elastomeric O-ring that is supported by the lower portion 114B, although other sealing configurations can be used as desired. The piston assembly 150 has a piston guide 154 that has a lower portion 156 with a longitudinally extending bore 158. The piston guide 154 has a cylindrically shaped upper portion 160 that is disposed within a cavity 162 of the hooding cap 124, as shown. The piston guide upper portion 160 has a pressure equalizing bore 164 extending therethrough and in fluid communication with the bore 158.

A second piston assembly 165, serving to determine the lower pressure limit of the predetermined pressure range, has a cylindrically shaped shuttle member 166 having a central bore 168 extending there through. The central bore 168 has a large diameter at the lower end of the piston shuttle member 166 and a threaded smaller diameter at the upper end thereof. The outer diameter of the piston shuttle member 166 is dimensioned so that it is slidably disposed for up and down movement in the piston guide bore 158.

A piston shaft, or rod, 170 has a threaded upper end that is engaged with the threaded smaller diameter portion of the central bore 168, as shown. The distal lower end of the piston shaft 170 connects to a compound seal assembly 172 that serves to seal the vapor space 106. A compound seal assembly includes a disk shaped over pressure seal member (piston) 174 and a disk shaped under pressure seal member (piston) 176 that together seal the vapor space 106 when the pressure of the vapor space 106 is within the predetermined pressure range mentioned above. The over pressure seal member 174 has an annular central hub 178 through which the lower end of the piston shaft 170 extends, the lower end of the piston shaft 170 threaded for engagement with a centrally disposed bore (not separately numbered) in the under pressure seal member 176.

The over pressure seal member 174 has a plurality of fluid flow holes 180 spaced about and surrounding the central hub 178 to form an outer ring shaped rim portion 182 joined to the central hub 178 by the webbing between the fluid flow holes 180. The fluid flow holes 180 are sealed by the upper surface of the under pressure seal member 176 when held in contact with the upper pressure seal member 174. An outer sealing surface 184 of the rim portion 182 is beveled to mate with a beveled annular shoulder portion 186 formed by the lower portion 114B of the support canister 114. The above mentioned annular seat 152 is supported in a groove in the shoulder portion 186 to abut and seal against the outer sealing surface 184 of the rim 182.

The rim 182 of the over pressure seal member 174 has a beveled inner surface 188 that mates with a beveled surface of the under pressure seal member 176, and an O-ring member 190 is supported in a groove in the inner surface 188 to abut and seal against the beveled surface of the under pressure seal member 176.

Returning to the piston guide 154, connected thereto is an upwardly extending threaded adjusting rod member 192 that has a lower end threadingly engaged with a threaded bore (not separately numbered) in the piston guide upper portion 160. The adjusting rod member 192 extends upwardly through a bore (not separately numbered) in the hooding cap 124, and an adjusting nut 194. As will become clear below, the position of the adjusting nut 194 on the adjusting rod member 192 determines the placement of the piston guide 154 relative to the hooding cap 124. As desired, a protective cover 196 can be provided over the protruding portion of the adjusting rod member 192.

A helical first spring 200 surrounds the piston assembly 150 and is compressed between the piston guide upper portion 160 and the over pressure seal member 174 of the compound seal assembly 172. A helical second spring 202 surrounds the piston shaft 170 and disposed in compression between the piston shuttle member 166 and the central hub 178 of the over pressure seal member 174. The compression (biasing force) of the first spring 200 is set to correspond to the upper pressure value of the predetermined pressure range and the second spring 202 is set to match the lower pressure value of the predetermined pressure range.

The pressure from the vapor space 106 within the storage vessel will apply an upwardly directed force upon the compound seal assembly 172, and this upwardly directed force will be countered by the force of the first spring 200. The amount of the upwardly directed force will be determined in relation to the pressure of the vapor space 106 and the areal extent of the downwardly facing surface area of the compound seal assembly 172 exposed to the vapor space. This upwardly directed force will be countered by a downwardly directed force by the pressure of the surrounding atmosphere upon the areal extent of the upwardly facing surface of the compound seal assembly 172 as communicated there against via the vent holes 142 in the support canister 114.

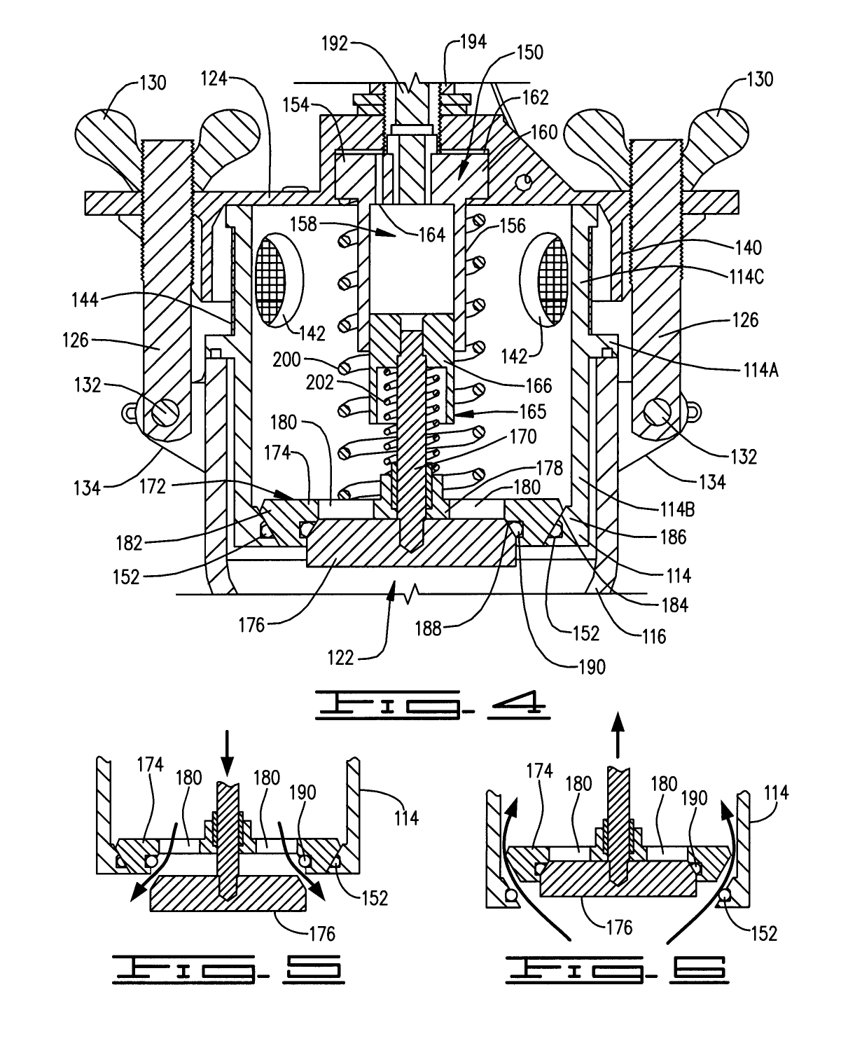

When the pressure of the vapor space 106 falls below the lower pressure limit of the predetermined pressure range, the under pressure seal member 176 will be pulled downwardly, separating from the over pressure seal member 174 to open the fluid flow holes 180 and establish communication with the vapor space 106. Such vacuum relief is generally depicted in FIG. 5.

So long as the pressure of the vapor space 106 remains within the predetermined pressure range, the first and second springs 200, 201 will keep the compound seal assembly together and sealing the vapor space from communication to the surrounding atmosphere. That is, the vapor pressure, countering the force of the second spring 202, will push the under pressure seal member 176 upwardly against the upper pressure seal member 176 to close the fluid flow holes 180. The first spring 200 presses against the compound seal assembly 172 so that the upper pressure seal member is pressed into sealing engagement against the annular seat 152.

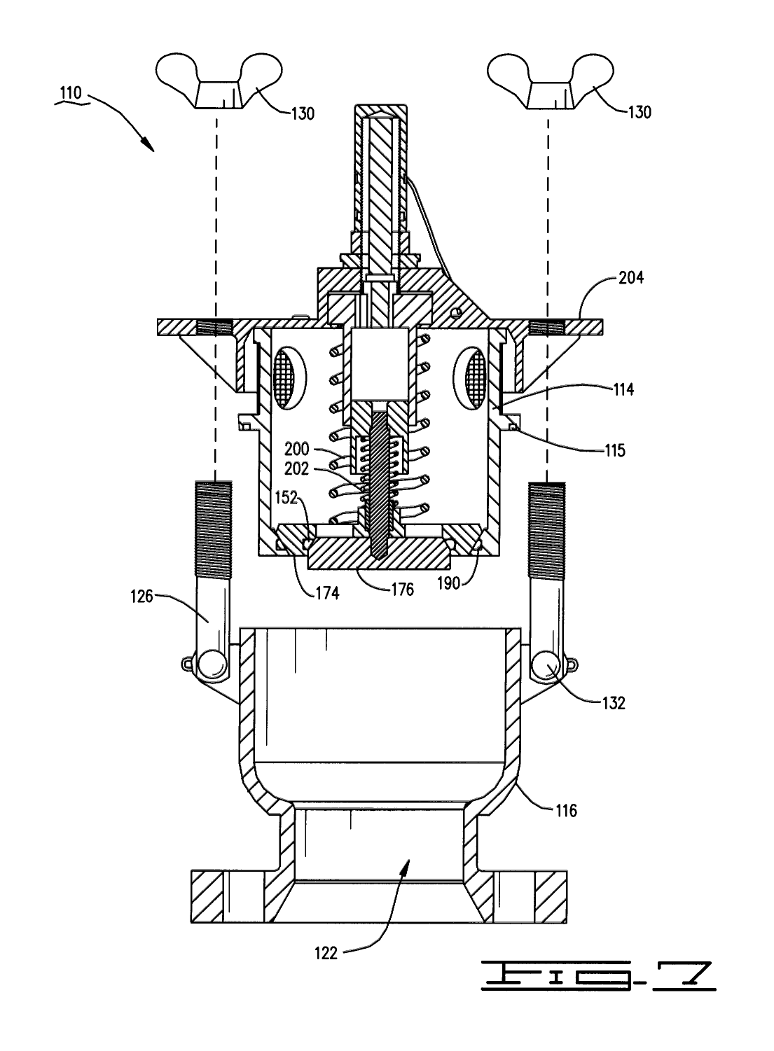

At such time that the pressure within the vessel space exceeds the upper threshold of the predetermined pressure range, both seal members (pistons) 174, 176 will move upwardly, allowing fluid to pass from the vapor space into the interior of the assembly 110 and out to the surrounding air atmosphere. Such overpressure relief is generally depicted in FIG. 6.

Moving the adjusting nut 194 on the adjusting rod member 192 advances or retracts the piston guide 154 into the support canister 114, thus increasing or decreasing the compressive force exerted by the first spring 200 on the compound seal assembly 172, and thereby adjusting the force necessary in the vapor space 106 to move the compound seal assembly 172 away from the O-ring seat 152 (see FIG. 6).

The extension of the piston shaft 170 downwardly from the piston shuttle member 166 is adjustable by rotating to increase or decrease the depth of penetration of the upper threaded end of the piston shaft 170 with the treaded bore of the piston shuttle member 166, thereby increasing or decreasing the force on the second spring 202. This increases or decreases the negative pressure required on the under pressure seal member 172 to separate it from the over pressure seal member 174 to expose the fluid flow holes 180 to fluid communication with the vapor space 106, permitting entry of atmospheric air until the pressure in the vapor space is increased to that of the surrounding atmosphere, at which time the vapor pressure on the under pressure seal member 172 will counter the force of the second spring 202 to again seal the fluid flow holes 180.

From the above, it will be appreciated how the pressure equalization assembly 110 stabilizes pressure of the vapor space 106 to remain within the predetermined pressure range. When a sufficient volume of vapor from the vapor space 106 has been vented to reduce the vapor space/exterior pressure differential to a resulting force that is less than the biasing force of the first spring 200, the piston assembly 150 will automatically reseat the compound seal assembly 172 on the sealing member 164, thereby closing the pressure relief assembly 214. Should the pressure in the vapor space drop below the ambient atmospheric pressure to reach the lower limit of the predetermined pressure range, air entry to the vapor space 106 will occur via the fluid flow holes 180 that are opened temporarily by the drawing downward of the under pressure seal member 172. Once the pressure of the vapor space 106 has reached the lower pressure limit, force of the second spring 202 will be countered by the vapor pressure to push the under pressure seal member 176 upwardly to again seal the fluid flow holes 180. FIG. 7 shows an exploded view of the pressure equalization assembly 110 of FIGS. 2-4. The upper portion of the assembly 110 housed within or otherwise integral with the canister 114, hereinafter referred to as a “canister assembly” 204, can be removed from and reinstalled into the lower body member 116 as shown. This provides easy access to the inner workings of the pressure equalization assembly 110 and, as desired, access to the vapor space 106 of the storage vessel 102. It will be appreciated that during such removal and reinstallation, the preload forces of the first and second springs 200, 202 will remain intact, and the respective piston sealing members 174, 176 will remain seated on the associated sealing members 152, 190.

Providing a self-contained canister assembly such as 204 can provide a number of benefits. The system will generally retain its calibrated pressure range settings after the canister assembly 204 has been removed and reinstalled, thereby ensuring continued operation over the desired pressure range. This also allows an existing canister assembly to be easily removed and replaced with a new, replacement canister assembly that has been calibrated and set to the appropriate pressure range settings. This can facilitate easy field servicing of the pressure equalization assembly, and tank reconfigurations (e.g., changing to a different operational pressure range).

The self-contained canister assembly 204 also ensures that the pistons 174, 176 remain correctly aligned and seated on the associated sealing members 152, 190, which reduces the likelihood that a seal interface misalignment will occur as the canister assembly is lowered into the lower body member 116. Finally, the canister assembly can be easily installed into the lower body member 116 to bring the sealing member 115 into contact with the upper surface of the body member 116 without requiring the user to exert a downwardly directed force to overcome the spring forces of the springs 200, 202. Thus, the spring force upon the pistons 174, 176 is independent of the insertion force required to install the canister assembly 204 into the lower body member 116.

While the pressure equalization assembly 110 is shown to utilize a pair of opposing threaded fasteners 126, 130 to secure the canister assembly 204 to the base housing member 116, it will be appreciated that such is merely for purposes of showing an illustrative embodiment and is not limiting. It will be appreciated that any number of fasteners can be utilized (e.g rivets, tape, wire, clamps, zip ties, integrated fasteners, rotate/locking flanges, latches, etc.) in order to facilitate the removability and replaceability of the canister assembly 204 relative to the base housing member 116 while maintaining the structural integrity and interchangeability of the canister assembly and the base housing member.

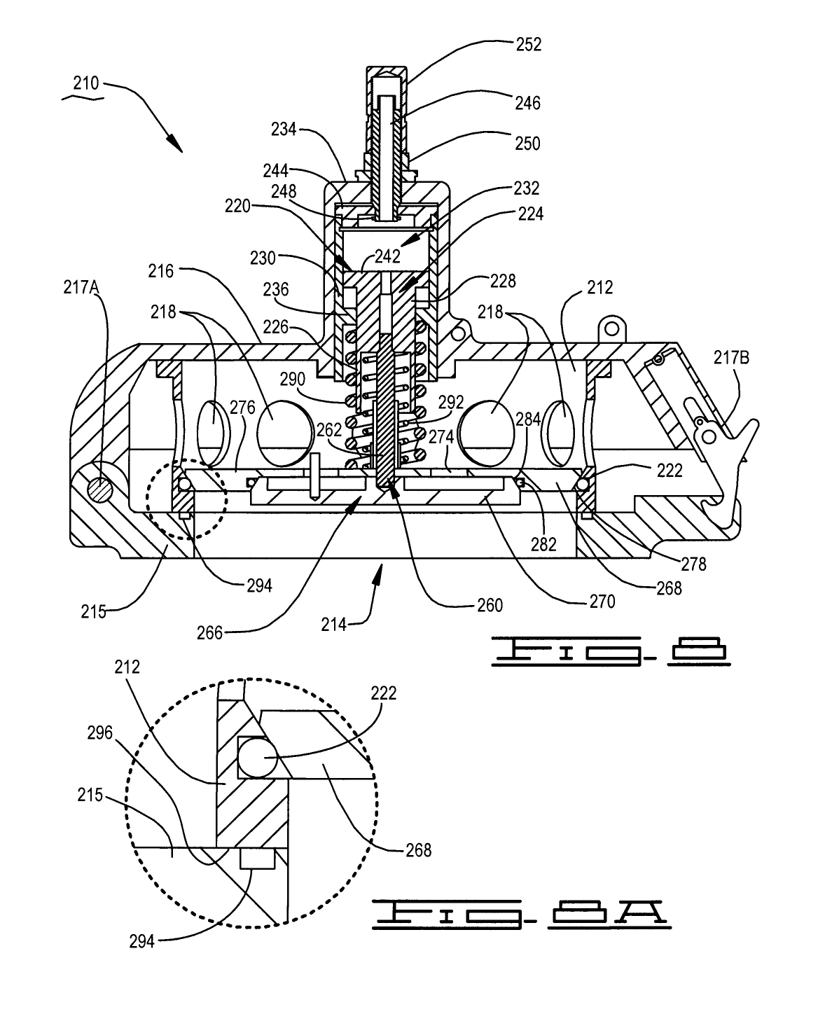

An alternative pressure equalization assembly 210 is shown in FIG. 8, with an enlargement of a portion of the assembly 210 provided in FIG. 8A. This alternative embodiment is generally similar in construction and operation to the embodiment of FIGS. 2-7 and is particularly well suited for attachment over a thief hatch aperture of a vessel.

As will be recognized by those skilled in the art, a thief hatch in a storage vessel commonly incorporates a relatively large aperture that is normally closed off by a hinged hatch or other sealing structure. The hatch is opened to allow an individual to lower a cup or other collection member into the vessel to retrieve a sample of the contents therein. In some cases, the thief hatch access may be sufficiently large to allow a user to climb down through the aperture and into the vessel. The embodiment of FIG. 8 thus serves the dual purpose of providing thief hatch access to the interior of a vessel when opened, and pressure equalization of the vessel when closed.

The pressure equalization assembly 210 includes an underpressure (that is, a vacuum) relief mechanism and an overpressure relief mechanism disposed within a housing (canister) 212. The housing 212 is generally characterized as a hollow cylindrical member having an internal passageway 214, and mates with a peripherally extending base housing member (flange) 215. The flange 215 may be provided with a plurality of bolt holes (not shown) through which bolts extend to attach the pressure equalization assembly 210 adjacent a thief hatch aperture in the storage vessel 102 so that the passageway 214 communicates with the vapor space 106 of the vessel (see FIG. 1).

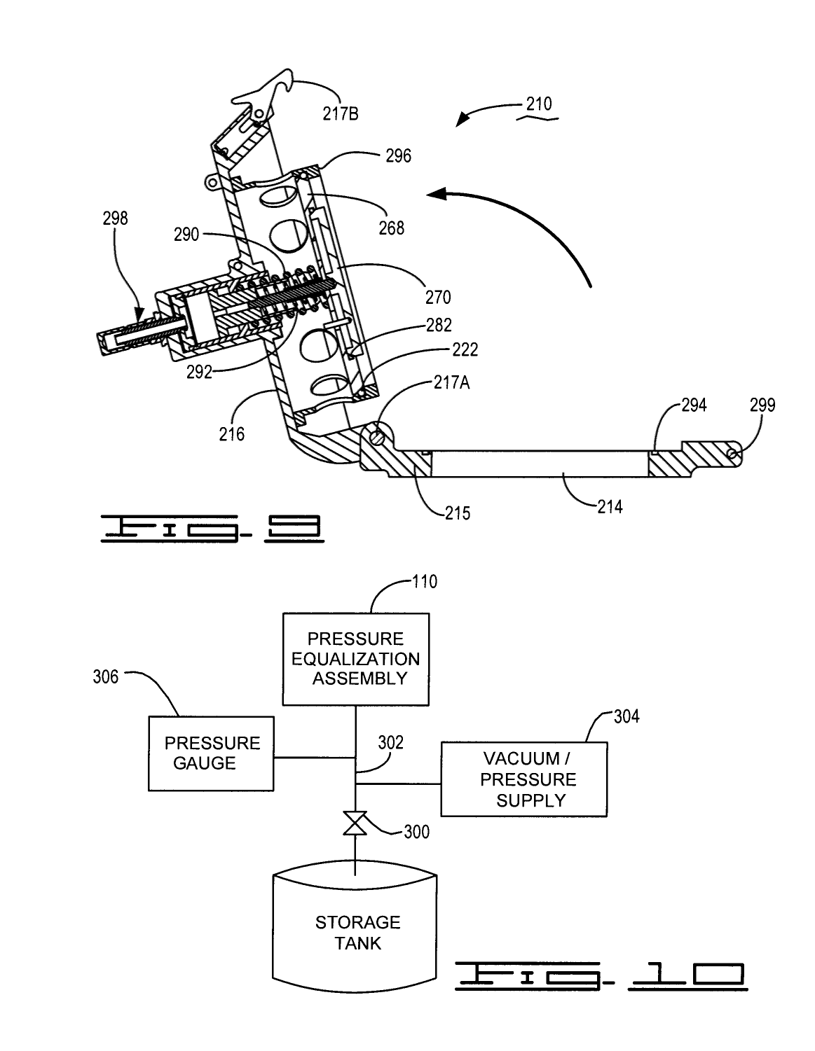

A pivotally supported hooding cap, or top cover 216 fits over the upper end of the housing 212. The hooding cap 216 is connected to the lower flange 215 by a hinge pin 217A and is latched by a pivotal hook latch 217B disposed on an opposing side of the hinge pin. With the pivotal hook latch 217B unlatched and pivoted aside, as before the upper portion of the assembly 210 can be rotated to an open position to provide access to the upper end of the housing 212, as generally depicted in FIG. 9.

The hooding cap 216 can function as a weather guard that extends about and is spaced from the outer surface of the upper housing 212. Several vent holes 218 are spatially disposed about the housing 212 near its top portion and arranged to be partially hooded by the annular cap 216. As necessary, a wire mesh screen member (not shown) or the like can be positioned to cover the vent holes 218 to prevent debris from entering the internal passageway 214.

A first piston assembly 220 normally seals the vapor space 106 from the surrounding atmosphere by engaging an annular seal 222 that is characterized as an elastomeric O-ring supported on the lower portion of housing 212, although other sealing configurations can be used as desired. The piston assembly 220 has a piston shuttle member 224 with hollow cylindrical lower portion 226 and a substantially solid cylindrical upper portion 228. A central bore extends through the upper portion and communicates with the hollow of the lower portion, the lower portion of the central bore being threaded.

A hollow, cylindrically shaped piston guide 230 is disposed in a cavity 232 formed by an upwardly extending support dome portion 234 of the hooding cap 216, as shown. The piston guide 230 can be provided with an annularly shaped shoulder ridge 236 near its medial portion, dividing the hollow interior of the piston guide 230 into an upper chamber and a lower chamber; the shoulder ridge provides a passage channel having an internal diameter dimensioned to permit free passage of the cylindrically shaped lower portion 226 of the piston shuttle member 224. The piston shuttle member 224 has a disk shaped portion 242 having an outer diameter sized to be slidingly disposed in the upper chamber, the shoulder ridge 236 extending to abut the disk portion 242 and thus limiting the downward travel of the shuttle member 224. A pressure equalizing bore (not shown) can be provided as desired in the disk portion 242 to equalize the pressure between the upper and lower chambers.

A cap member 244 is threadingly connected to the upper end of the piston guide 230; and a threaded, adjusting rod member 246 extends upwardly from, and is threadingly engaged with a threaded bore (not separately numbered), in the dome portion 234 of the hooding cap 216. Preferably, the upper end of the rod member 246 is squared to accept a wrench for advancing or retracting the rod member 246 relative to the dome portion 234.

The lower end of the rod member 246 extends through a bore (not separately numbered) in the top of the cap member 244 and is retained in connection therewith via a cotter pin 248, permitting the rod member 246 to rotate freely relative to the cap member 244, thereby raising or lowering the piston guide 230 in the cavity by rotating the rod member 246. A locking nut 250 on the threaded rod member 246 serves to lock the rod member 246 in position once advanced or retracted as desired. Preferably, a protective cover 252 is mounted over the protruding portion of the rod member 246.

The pressure equalization assembly further comprises a second piston assembly 260 that has a piston rod 262 with a threaded upper end that is threadingly engaged with the lower, threaded end of the central bore of the piston shuttle member 224. The threaded lower end of the piston rod 262 connects to a compound seal assembly 266. The compound seal assembly 236 has a disk shaped over pressure seal member (piston) 268 and a disk shaped under pressure seal member (piston) 270 that together seal the internal passageway 114 when the pressure of the vapor space 106 in the vessel 102 is within the predetermined pressure range mentioned above.

The over pressure seal member 268 has an annular central hub through which the piston rod 262 extends; the lower end of the piston rod 262 is threaded and engages a centrally disposed threaded bore (not separately numbered) in the under pressure seal member 270.

The over pressure seal member 268 has a plurality of fluid flow holes 274 spaced about and surrounding the central hub to form an outer ring shaped rim portion 276 joined to the central hub by the webbing between the fluid flow bores 274. The fluid flow holes 274 are sealed by the under pressure seal member 270 when held in contact with the upper pressure seal member 268.

An outer surface 278 of the rim portion 276 is beveled to mate with the above mentioned annular seal 222 (O-ring) which is supported in a lower groove of the housing member 212. The over pressure seal member 268 has an inner groove that supports a second annular seal 282 (O-ring) abuts and seals against a corresponding beveled outer surface 284 of the under pressure seal member 270.

The first piston assembly 220 has a helical spring 290 that is supported in compression between the over pressure seal member 268 and the shoulder ridge 236 of the piston guide 230. The second piston assembly 260 has a helical second spring 292 nested within the first spring 290 and disposed to surround the piston rod 262. As before, the compression force of the first spring 290 is set to match the upper pressure value of the predetermined pressure range and the compression force of the second spring 292 is set to match the lower pressure value of the predetermined pressure range.

When the pressure equalization assembly 210 is sealingly mounted to the thief hatch of the liquid storage vessel 102, the pressure of the vapor space 106 will be communicated by the internal passageway 214 against the compound seal assembly 266 and is countered by the force of the first spring 290. When the pressure in the vapor space 106 exceeds the upper limit of the predetermined pressure range, the vessel pressure will force the over pressure seal member 268 and the under pressure seal member 270 upwardly, moving the outer surface 278 of the rim 276 away from the annular seal 222, providing open communication to the vent holes 218 while the pressure exceeds the upper limit. Once the pressure of the vapor space 106 is reduced to within the predetermined pressure range, the first helical spring 290 will force the over pressure seal member 268 and the under pressure seal member 270 downwardly so that the over pressure seal member 268 will seal against the annular seal 222

When the pressure of the vapor space 106 falls below the lower pressure limit of the predetermined pressure range, the under pressure seal member 270 will be pulled downwardly against the second helical spring 292, separating the under pressure seal member 270 from the over pressure seal member 268 to open the fluid flow bores 274 to fluid communication with the vapor space 106, and surrounding atmospheric air will flow through the vent holes 218 to the vapor space 106. Once the pressure of the vapor space 106 has risen to a value that exceeds the lower limit of the predetermined pressure range, the second helical spring 292 will extend to lift the under pressure seal member 270 to sealing reengagement with the O-ring seal 282.

As shown in greater detail in FIG. 8A, the lower base flange 215 includes an annular seal 294. The seal 300 has a rectilinear cross-sectional shape, although other shapes and styles of sealing members can be used. A lower facing surface 296 of the housing member 212 contactingly engages the seal 300 when the assembly 210 is in the closed position (FIGS. 8-8A). This provides the pressure equalization assembly 210 with a “canister assembly” 298 which can be lifted up and away from the lower flange 215, as shown in FIG. 9. The latch 217B selectively engages and disengages a latch pin 299 (FIG. 9) as the assembly is transitioned between the closed and open positions.

As before, an advantage of the self-contained canister assembly 298 of the pressure equalization assembly 210 is that the respective preload forces of the springs 290, 292 are maintained upon the pistons 268, 270 even when the pressure equalization assembly 210 is transitioned to the open position (FIG. 9). This can help to maintain the operational accuracy of the assembly vacuum and positive pressure setpoints since the pistons 268, 270 are not released and reset as the assembly 210 is moved between the hatch closed and hatch open positions.

Maintaining the spring preload forces in this fashion further reduces the force necessary to transition the assembly 210 back to the closed position of FIG. 8, since the user need not overcome the spring force that normally urges the springs in the closed position in order to engage the latch 217B. This can be particularly beneficial when relatively larger cross-sectional pressure equalization assemblies, and relatively large spring forces, are used. It will be noted that any number of sizes of apertures can be covered by the various embodiments presented herein, including apertures that are extremely small and apertures that are sufficiently large to enable a user to climb therethrough to gain access to the interior of the vessel.

While it is contemplated that the canister assembly 298 will remain permanently affixed to the base flange via the hinge pin 217A, as desired the canister assembly can be made easily removable and replaceable through the use, for example, of a removable hinge pin or similar. This allows a replacement, pre-calibrated canister assembly (with the same, or different, pressure range settings) to be installed without affecting the existing mounting configuration.

On-site field calibration operations can be performed as desired to set the respective upper and lower pressure threshold boundaries. FIG. 10 provides a simplified functional block diagram of the storage tank 102 of FIG. 1 in conjunction with the equalization pressure equalization assembly 110 of FIGS. 2-7. It will be understood that the functional block diagram of FIG. 6 applies equally well to other configurations such as the thief hatch embodiment of FIGS. 8-9.

A user operated manual valve 300, such as a ball valve, can be connected via a conduit 302 between the tank 102 and the pressure equalization assembly 110. During an on-site calibration of the system, a pressure/vacuum supply 304, such as a portable tank, compressor, vacuum pump, etc., and a pressure gauge 306, preferably with a GUI display (numeric pressure value readout, etc.) can be connected to the conduit 302.

After closing the valve 300, the user can utilize the supply 304 to set the pressure sensed by the pressure equalization assembly 110 to a first desired level, such as a first vacuum (negative) pressure, and adjust the pressure equalization assembly 110 until it operates to open at this desired level. Such adjustment can be carried out by beginning with the vacuum pressure piston being in a closed position, and changing the spring tension until the piston moves to the open position. The holding pressure of the assembly 110 can be determined via the gauge 306. For example, the assembly 110 may be set to operate to nominally open at minus 0.4 oz/in² and thereafter close and hold minus 0.3 oz/in² of vacuum pressure.

The foregoing steps can be repeated by supplying a positive pressure to the pressure equalization assembly 110 and adjusting the spring force upon the positive pressure piston until the pressure opens it at this second desired level. As before, the holding pressure can be determined via the gauge 306. For example, the system may operate to open at a positive pressure of about 6.0 oz/in² and thereafter close and hold at a positive pressure of about 5.9 oz/in². In this example, the operational pressure differential range would thus be from a negative pressure of 0.4 oz/in² to a positive pressure of 6.0 oz/in²; pressures at or beyond this range would result in the opening of the equalization pressure equalization assembly 110, while the pressure equalization assembly 110 would remain closed for pressure excursions that remained within this range.

From the above, it will now be appreciated that the pressure equalization assembly as variously embodied herein can operate to stabilize pressure of the vapor space of a liquid storage vessel to remain within a predetermined pressure range. When a sufficient volume of vapor from the vapor space has been vented to reduce the vapor space/exterior pressure differential to a resulting force that is less than the biasing force of the first spring, the first piston assembly will automatically reseat the compound seal assembly on the annular seal, thereby closing the pressure relief assembly. Should the pressure in the vapor space drop below the ambient atmospheric pressure to reach the lower limit of the predetermined pressure range, air entry to the vessel will occur via the fluid flow holes opened temporarily by the drawing downward of the under pressure seal member. Once the pressure of the vessel has reached the lower pressure limit, the under pressure seal member will be forced to again seal the vessel.

Unlike many prior art equalization systems which fail to hold a setpoint pressure differential, the various embodiments disclosed herein can be configured to maintain the storage tank in a continuously sealed (closed) condition until and only at such time that the pressure of the vapor space exceeds the upper limit or falls below the lower limit of the predetermined pressure range, after which the system returns to maintain a sealed condition. The pressure in the vapor space will thus not necessarily equal that of the surrounding atmosphere, but will be within the predetermined range of acceptable pressure differentials.

It follows that, depending on the structural integrity of a storage tank, the tank may be able to remain fully sealed against the external environment over a wide range of environmental cycling conditions. For example, a given storage vessel may heat up during a hot day hours and cool off during night hours, and if the pressure excursions can be safely handled by the vessel, no venting to the external atmosphere will occur. This advantageously prevents environmental contamination by eliminating the unnecessary venting of volatile fumes to the surrounding atmosphere, and may prevent the vessel owner from incurring fines or other sanctions from a regulatory authority carrying out on-site “sniffer” type inspections in an attempt to detect emitted vapors.

In some embodiments, the respective upper and lower pressure limits can be set in relation to the structural capabilities of the vessel so that, should changes in internal pressure be sufficient to approach such can result in damage, the system will safely vent (or admit) fluid to prevent such damage, but otherwise prevent venting or admitting of fluid in other circumstances. Exemplary structural capabilities of some types of storage tanks may be on the order of about a positive pressure of 6.0 ounces per square inch (6.0 oz/in²) and about a negative pressure of 0.4 oz/in². The setpoint pressure differential thresholds can be set at some prorated percentage, such as eighty percent of these values.

The various embodiments presented herein further advantageously operate to provide easy access to the interior of the vessel by removal/pivotal rotation of the operational upper portion of the assembly. The spring preload and seal interfaces remain intact, ensuring correct replacement and operation of the assembly when transitioned back to the closed position.

It will be appreciated that the various embodiments discussed herein provide a number of advantages over the prior art. The various embodiments provide both overpressure and underpressure relief at specified levels, while normally closing the vapor space of the storage vessel to the surrounding atmosphere at all other times. The assembly is readily constructed and maintained, and is contemplated to provide reliable operation over a variety of changing environmental conditions.

For purposes of the appended claims, terms such as “removably engageable” and the like will be construed consistent with the foregoing discussion to describe a self-contained assembly as exemplified by the canister assemblies 204, 298 that can be removed from and subsequently replaced into a base housing member as exemplified by the base housing members 116, 215.

It will be clear that the various embodiments presented herein are well adapted to carry out the objects and attain the ends and advantages mentioned as well as those inherent therein. While presently preferred embodiments have been described for purposes of this disclosure, numerous changes may be made that will readily suggest themselves to those skilled in the art and that are encompassed in the spirit of the subject matter disclosed and as defined in the appended claims.

What is claimed is:

1. A pressure equalization assembly for selectively sealing the vapor space of a liquid storage tank to maintain the pressure of the vapor space to a pressure value within a selected predetermined pressure range, comprising:
a base housing member adapted to be mounted to the tank adjacent a tank aperture in fluidic communication with a vapor space of the tank;
a canister assembly adapted for removable engagement with the housing member between a closed position and an open position, the closed position establishing a fluidic seal interface between the housing member and the canister assembly, the open position providing user access to the vapor space through the tank aperture, the canister assembly comprising a compound seal assembly with first and second pistons biased against corresponding first and second seal members while the canister assembly is in both the closed position and the open position; and
a third annular seal member disposed between the canister assembly and the base housing member to establish the fluidic seal interface.

2. The pressure equalization assembly of claim 1, further comprising an external fastener which secures the canister assembly to the base housing member and compresses the third annular seal.

3. The pressure equalization assembly of claim 1, in which the canister assembly comprises a first surface oriented in facing relation to the housing member, and in which the annular seal member is disposed in a groove formed in said first surface for contacting engagement with a second surface of the housing member oriented in facing relation to the first surface.

4. The pressure equalization assembly of claim 1, in which the housing member has a first surface oriented in facing relation to the canister assembly, and in which the annular seal member is disposed in a groove formed in said first surface for contacting engagement with a second surface of the canister assembly oriented in facing relation to the first surface.

5. The pressure equalization assembly of claim 1, in which the canister assembly further comprises an attachment flange adapted to engage a fastener to secure the canister assembly to the housing member and to alternatively facilitate removal of the canister assembly from mating engagement with the housing member in a linear direction away from the aperture when transitioned to the open position.

6. The pressure equalization assembly of claim 1, in which the canister assembly is coupled to the housing member via a hinge assembly so that the canister assembly is rotated away from the housing member when transitioned to the open position, and a latch mechanism secures the canister assembly to the base housing member when the canister assembly is rotated to the closed position, the latch mechanism having an insertion force independent of bias forces upon the first and second pistons supplied by the compound seal assembly.

7. The pressure equalization assembly of claim 1, in which the first piston advances away from the first seal member responsive to the pressure of the vapor space exceeding an upper threshold value to facilitate a flow of fluid from the vapor space through the housing and the canister assembly to an external atmosphere, and in which the second piston advances away from the second seal member responsive to the pressure of the vapor space falling below a lower threshold value to facilitate a flow of fluid from the external atmosphere and through the canister assembly and housing member to the vapor space.

8. The pressure equalization assembly of claim 1, in which the canister assembly comprises a top cover and an interior annular housing which surrounds the compound seal assembly and maintains the first and second pistons in contacting engagement with the respective first and second seal members when the canister assembly is transitioned to the open position.

9. The pressure equalization assembly of claim 8, in which the compound seal assembly further comprises coiled first and second springs which respectively bias the first and second pistons, the second spring nested within and axially aligned with the first spring.

10. The pressure equalization assembly of claim 9, in which the canister assembly further comprises an adjustment mechanism that facilitates independent adjustment of the biasing forces supplied by the first and second springs while the canister assembly is in the closed position and while the canister assembly is in the open position.

11. A pressure equalization assembly, comprising:
a canister assembly comprising a top cover and an interior annular canister housing, a compound seal assembly nested within the canister housing and comprising axially aligned moveable first and second pistons, and a spring assembly comprising first and second axially aligned springs, the first spring exerting a first spring force upon the first piston and the second spring exerting a second spring force upon the second piston;
a base housing member adapted for mounting engagement with a storage vessel adjacent an aperture extending through the vessel in fluidic communication with a vapor space thereof, the base housing member adapted to sealingly engage the canister assembly in a closed position and adapted to facilitate removal of the canister assembly from the base housing member in an open position, the canister housing having a lower surface that maintains the first and second spring forces upon the respective first and second pistons in both the closed and open positions;
an annular sealing member contactingly disposed between the canister assembly and the base housing member when the canister assembly is in the closed position; and
an external fastener which clamps the canister assembly to the base housing member and compresses the annular sealing member therebetween.

12. The pressure equalization assembly of claim 11, in which the annular canister housing comprises at least one through-hole aperture extending from an annular interior sidewall to an exterior annular sidewall of the canister housing to facilitate a flow of fluid between the vapor space and an exterior atmosphere responsive to a selected one of the first or second pistons moving away from a corresponding first or second seal member while the canister assembly is in the closed position.

13. The pressure equalization assembly of claim 11, wherein responsive to an increase in pressure of the vapor space of the vessel above a first selected threshold, the first and second pistons move together in contacting abutment to facilitate fluidic flow from the vapor space and through the pressure equalization assembly to an exterior atmosphere.

14. The pressure equalization assembly of claim 13, wherein responsive to a decrease in pressure of the vapor space below a lower second selected threshold, the second piston disengages and moves away from the first piston to facilitate fluidic flow from the exterior atmosphere and through the pressure equalization assembly to the vapor space.

15. The pressure equalization assembly of claim 11, in which the annular sealing member is disposed in a channel in a selected one of the base housing member or the interior annular canister housing for contacting engagement with a remaining one of the base housing member or the interior annular canister housing.

16. The pressure equalization assembly of claim 11, in which the fastener comprises a threaded shaft and a nut which cooperate to facilitate removal of the canister assembly from the base housing member by a user.

17. The pressure equalization assembly of claim 16, in which the canister assembly is hinged to the base housing member to facilitate rotation of the canister assembly relative to the base housing member during transition to the open position, and the fastener comprises a latch which selectively clamps the canister assembly to the base housing member in the closed position, the latch engaged with an insertion force independent of the biasing forces upon the first and second pistons.

18. The pressure equalization assembly of claim 11, in which the first piston advances away from a first seal member supported by the canister housing responsive to the pressure of the vapor space exceeding an upper threshold value to facilitate a flow of fluid from the vapor space through the housing and the canister assembly to an external atmosphere, and in which the second piston advances away from a second seal member supported by the canister housing responsive to the pressure of the vapor space falling below a lower threshold value to facilitate a flow of fluid from the external atmosphere and through the canister assembly and housing member to the vapor space.

19. The pressure equalization assembly of claim 9, in which the canister assembly further comprises an adjustment mechanism that facilitates independent adjustment of the biasing forces supplied by the first and second springs while the canister assembly is in the closed position and while the canister assembly is in the open position.

20. A pressure equalization assembly, comprising:
a base housing member adapted for coupling to a storage vessel adjacent an aperture extending therethrough;
an external fastener; and
a self-contained canister assembly comprising axially aligned first and second pistons in respective biased engagement against first and second annular seal members to provide overpressure and underpressure relief for a vapor space of a storage vessel, the canister assembly further comprising an annular interior housing which supports the first and second pistons in said biased engagement prior to mating engagement of the canister assembly with the base housing member, the annular interior housing further comprising a sealing surface which contactingly engages a third annular sealing member between the sealing surface and a corresponding surface of the base housing member to establish a fluidic seal during mating engagement of the canister assembly with the base housing member, the fastener securing the canister assembly to the base housing member.

21. The pressure equalization assembly of claim 20, in which the fastener compresses the third annular sealing member between the respective sealing surfaces of the canister assembly and the base housing member.

22. The pressure equalization assembly of claim 20, in which the canister assembly is removably connected to the base housing member via a plurality of threaded fasteners located on opposing sides of the canister assembly which facilitate removal of the canister assembly from the base housing member by a user, wherein insertion forces used to secure the fasteners are independent of biasing forces applied to the first and second pistons.

23. The pressure equalization assembly of claim 20, in which the canister assembly is hinged to the base housing member to facilitate rotation of the canister assembly relative to the base housing member during transition to an open position, the fastener comprising a latch which secures the canister assembly to the base housing member in a closed position.

24. The pressure equalization assembly of claim 20, in which the first piston advances away from a first seal member supported by the canister housing responsive to the pressure of the vapor space exceeding an upper threshold value to facilitate a flow of fluid from the vapor space through the housing and the canister assembly to an external atmosphere, and in which the second piston advances away from a second seal member supported by the canister housing responsive to the pressure of the vapor space falling below a lower threshold value to facilitate a flow of fluid from the external atmosphere and through the canister assembly and housing member to the vapor space.

25. The pressure equalization assembly of claim 20, in which the base housing member is characterized as a bowl-shaped recess and the mating engagement of the canister assembly with the base housing member comprises inserting the interior annular housing into the bowl shaped recess and engaging the fastener through a top cover of the canister assembly to secure the canister assembly to the base housing member.
